(19) United States
(12) Patent Application Publication
(10) Pub. No.: US 2014/0083474 A1
(43) Pub. Date: Mar. 27, 2014

(54) Cleanroom and Automatic Cleaning Container

(71) Applicants: Zenghong Chen, Shenzhen City (CN); Chunhao Wu, Shenzhen City (CN); Kunhsien Lin, Shenzhen City (CN); Minghu Qi, Shenzhen City (CN); Zhenhua Guo, Shenzhen City (CN); Weibing Yang, Shenzhen City (CN)

(72) Inventors: Zenghong Chen, Shenzhen City (CN); Chunhao Wu, Shenzhen City (CN); Kunhsien Lin, Shenzhen City (CN); Minghu Qi, Shenzhen City (CN); Zhenhua Guo, Shenzhen City (CN); Weibing Yang, Shenzhen City (CN)

(73) Assignee: Shenzhen China Star Optoelectronics Technology Co. Ltd., Shenzhen, Guangdong (CN)

(21) Appl. No.: 13/642,544

(22) PCT Filed: Oct. 8, 2012
(86) PCT No.: PCT/CN2012/082538

§ 371 Date: Oct. 21, 2012

(30) Foreign Application Priority Data
Sep. 26, 2012 (CN) 201210364804.0

(51) Int. Cl. B08B 7/00

(52) U.S. Cl. 134/57 R; 134/113

(57) ABSTRACT

The present invention discloses a cleanroom for storing glass substrate and which is incorporated with a particle-monitoring device. The cleanroom further includes an automatic cleaning container for cleaning the particle-monitoring device. The cleanroom can conveniently perform a cleaning process to the tray and the particle-monitoring device. With this, the laborious cost is largely reduced.

### FIELD OF THE INVENTION

The present invention relates to a technical field of manufacturing a liquid crystal display panel, and more particularly, to a cleanroom and an automatic cleaning container.

### DESCRIPTION OF PRIOR ART

A liquid crystal display panel has to be a plurality of working processes so as to make it useable for final assembly of a liquid crystal display device. In generally, those working processes have to be performed under an environment of dust-free. In the currently, glass substrates are stored in a tray or stocker of a cleanroom, and are moved between different workstations by an automatic transporting apparatus to complete different working processes. During these processes, the airborne particles contained within the cleanroom play a great impact to the quality of the glass substrate. If the percentage of the airborne particles contained within a cleanroom exceeds a certain preset level, then the yield of the liquid crystal display panel will be lowered accordingly.

Currently, the percentage and variation of the airborne particles contained in the cleanroom can be readily monitored by a monitoring device. However, the monitoring device is in contact with a spot in which the airborne particles leak in, and accordingly will accumulate onto the monitoring device after a certain period of usage. The contamination of the monitoring device will surely affect the accuracy of the operation of the monitoring device, and it will take a great deal of time to have the monitoring device clean manually. This will negatively affect the yield of the liquid crystal display panel.

### SUMMARY OF THE INVENTION

It is an object of the present invention to provide a cleanroom so as to resolve the laborious cleaning process of the monitoring device and shorten the cleaning time.

In order to resolve the issues encountered by the prior art, the present invention provides a technical solution by introducing a cleanroom for storing glass substrates configured with a particle-monitoring device and an automatic cleaning container for automatically cleaning the particle monitoring device.

The automatic cleaning container includes

A container both provided with a plurality of nozzles mounted on a sidewall of the container body;

A cover attached to the container body to jointly define a cleaning space; and

A controlling unit manipulating on or off to the nozzles to perform the cleaning process, and also open and close of the cover

In order to resolve the issues encountered by the prior art, the present invention provides a technical solution by introducing a cleanroom for storing glass substrates and configured with a particle-monitoring device, wherein the cleanroom is arranged with an automatic cleaning container to automatically perform cleaning process to the particle-cleaning device.

According to a preferred embodiment, wherein the cleanroom is incorporated with towers defining with a plurality of storing cells, each of the storing cells including:

A tray cell for a tray in which glass substrates are stored therein; and

An automatic cleaning cell in which the automatic cleaning container is disposed therein.

According to a preferred embodiment, wherein the automatic cleaning container comprises:

A container body provided with a plurality of nozzles mounted on a sidewall of the container body;

A cover attached to the container body to jointly define a cleaning space; and

A controlling unit manipulating on or off to the nozzles to perform the cleaning process, and also open and close of the cover.

According to a preferred embodiment, wherein the cover is embodied as a roller curtain.

According to a preferred embodiment, wherein the particle monitoring device includes:

A particle counter monitoring the number of the particles;

A wireless communication module interconnected to the particle counter, and in communicating with an external control center; and

A power supply electrically interconnected and providing power to the particle counter and the wireless communication module.

According to a preferred embodiment, wherein the particle-monitoring device further includes a bracket attached to the tray cell so as to install the particle counter, the wireless communication module, and the power supply thereon.

According to a preferred embodiment, wherein the cleanroom is incorporated with an automatic transporting apparatus for moving the tray and the particle-monitoring device.

According to a preferred embodiment, wherein the automatic transporting apparatus includes a forklift for moving the tray and the particle-monitoring device.

In order to resolve the issues encountered by the prior art, the present invention provides a technical solution by introducing an automatic cleaning container for cleaning a particle monitoring device, and a tray, comprising:

A container body provided with a plurality of nozzles mounted on a sidewall of the container body;

A cover attached to the container body to jointly define a cleaning space; and

A controlling unit manipulating on or off to the nozzles to perform the cleaning process, and also open and close of the cover.

The present invention can be concluded with the following advantages. As compared to the existing technology, the cleanroom is incorporated with an automatic cleaning container which performs a cleaning process to the tray and particle-monitoring device arranged within the cleanroom. The cleaning process can be easily and readily done while effectively lower the manual cost.

### BRIEF DESCRIPTION OF DRAWINGS

In order to give a better and thorough understanding to the whole and other intended purposes, features and advantages of the technical solution of the present invention, detailed description will be given with respect to preferred embodiments provided and illustrated herebelow in accompanied drawings. Apparently, with the spirit of the embodiments disclosed, person in the skilled in the art can readily come out with other modifications as well as improvements without undue experiment. In addition, other drawings can be readily achieved based on the disclosed drawings. Wherein

FIG. 1 is a perspective view of a cleanroom made in a preferred embodiment of the present invention;

FIG. 2 is an illustrational and cross sectional view of the cleanroom shown in FIG. 1;

FIG. 3 is an illustrational and structural view of a monitoring device shown in FIG. 1;

FIG. 4 is an illustrational view depicting the monitoring device shown in FIG. 3;

FIG. 5 is an illustrational view showing the monitoring device is contaminated;

FIG. 6 is an illustrational and perspective view of an automatic cleaning container shown in FIG. 1;

FIG. 7 is an illustrational view showing the cleaning container of FIG. 6 is under working situation 1;

FIG. 8 is an illustrational view showing the cleaning container of FIG. 6 is under working situation 2; and

FIG. 9 is an illustrational view showing the cleaning container of FIG. 6 is under working situation 3.

### DETAILED DESCRIPTION OF PREFERRED EMBODIMENT

In order clearly explain the technology of the embodiment illustrated in the present invention, a brief and concise description will be given along with the accompanied drawings. Apparently, the embodiments illustrated in the drawings are merely some typical embodiments and which can be readily modified by the skilled in the art without any additional laborious efforts so as to transform them into other drawings, and they should all be covered by the appended claims.

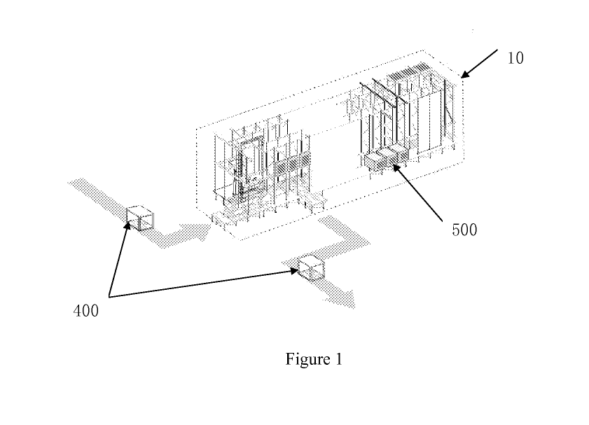

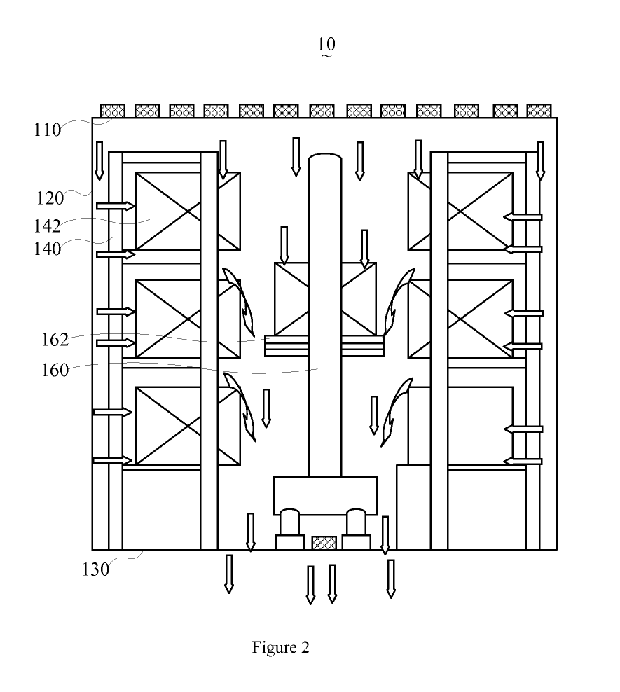

Referring to FIGS. 1 and 2, the present invention provides a cleanroom 10 for storing glass substrate and which is configured with top ceiling 110, at least a sidewall 120 and a bottom floor 130. The cleanroom 10 includes at least a storing tower 140, an automatic transporting apparatus 160, a particle-monitoring device 400, and an automatic cleaning container 500.

The storing tower 140 is arranged onto the bottom floor 130, and defines with a plurality of tray cells for storing trays 142, and a plurality of automatic cleaning cells for disposing automatic cleaning container 500. The tray 142 is used to store the glass substrates.

The automatic transporting apparatus 160 includes a forklift 162 to dispose and remove the tray 142, the particle-monitoring device 400, and the automatic cleaning container 500 from the cells.

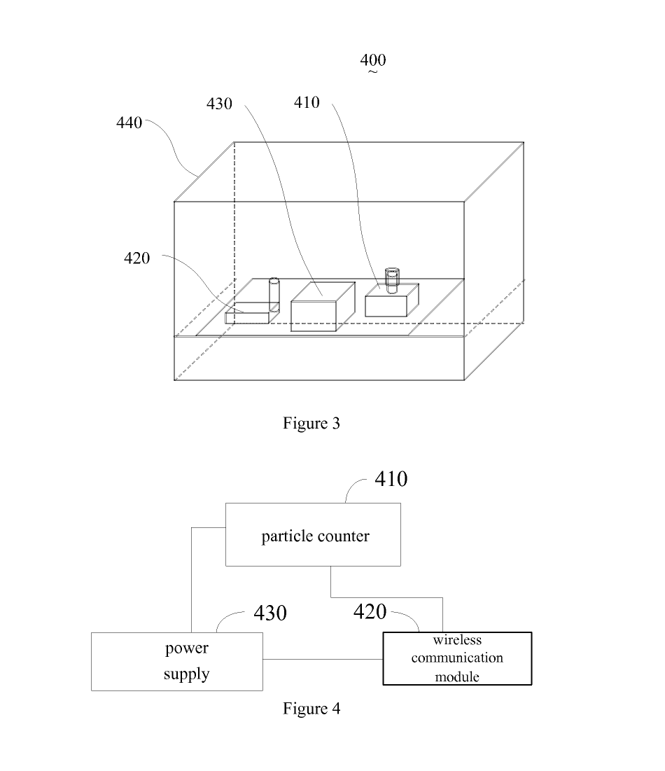

Referring to FIGS. 3 to 5, the particle-monitoring device 400 includes a particle counter 410, a wireless communication module 420, as power supply 430, and as bracket 440.

Wherein the particle counter 410 is used to monitor the quantity of the particles within the cleanroom 10. The wireless communication module 420 is interconnected to the particle counter 410 so as to provide instant counting to an external controlling center. The power supply 430 provides the necessary operational power to both the particle counter 410 and the wireless communication module 420. The bracket 440 is dimensioned to match with the tray cell so as to mount the particle counter 410, the wireless communication module 410, and the power 430 in the tray cell.

The particle-monitoring device 400 can be used to monitor several cleanrooms. As shown in FIG. 1, the particle monitoring device 400 can be used in one cleanroom 10, and he move to another cleanroom for checking the particles level.

The tray 142 and the particle monitoring device 400 are frequently moved by the automatic transporting apparatus 160 to different cells of the cleanroom 10. After it has been serviced for a period of time, the particles 450 could be accumulated onto the particle-monitoring device 400, and the tray 142, and not doubt they have to be cleaned. If the tray 142 and the particle-monitoring device 400 are cleaned manually, it takes time and laborious work. The production will be inevitably affected.

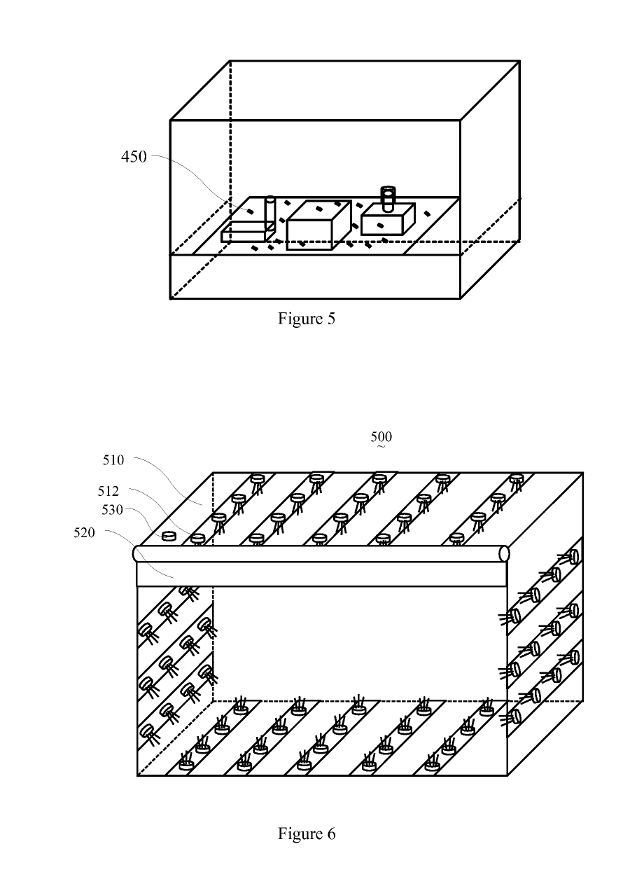

In light of this, the present invention provides an automatic cleaning container 500, and please refer to FIG. 5. The automatic cleaning container 500 is configured with a container body 510, a cover 520, and a controlling unit 530.

A sidewall of the container body 510 is installed with a plurality of nozzles 512 and a cleaning space can be defined by the container body 510 and the cover 520. The controlling unit 530 can be used to turn on/off of the nozzles 512 as well as open and close of the cover 520.

Substantially, the container body 510 has a rectangular shape in FIG. 5, while it should not be limited thereto. The container body 510 can be disposed into the automatic cleaning cell. Alternatively, some of the automatic cleaning cell can be contained to configure the container body 510. The cover 520 can be embodied as a roller curtain or a sliding door.

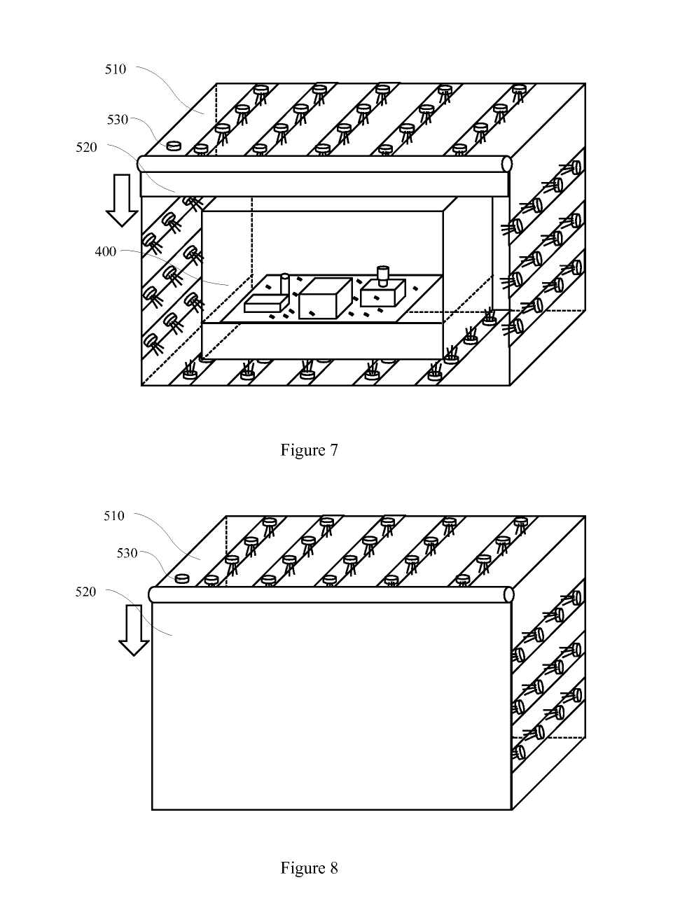

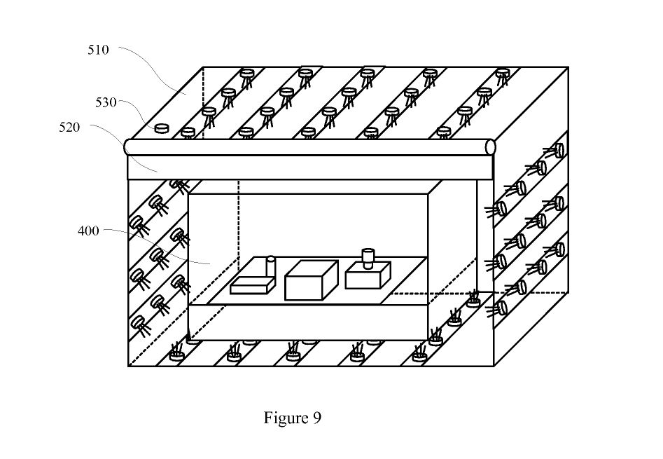

Referring to FIGS. 6 to 8 in which the working situations of the automatic cleaning container 500.

Where there is lots of particles accumulated onto the particle monitoring device 400 or the tray 142, then the particle monitoring device 400 can be moved into the automatic cleaning container 500 with the help of the automatic transporting apparatus 160, as cleanly shown in FIG. 6. Subsequently, the cover 520 is closed to contain the container body 510 with the manipulation of the controlling unit 530, such as shown in FIG. 7. Then, the controlling unit 530 will further manipulate the nozzle 512 to direct compressed airflow toward, the particle-monitoring device 400 or the tray 142 so as to remove the accumulated particles. After the cleaning process is completed, the cover 520 is opened again by the controlling unit 530, as shown in FIG. 8. Finally, the particle monitoring device 400 or the tray 142 are moved out by the automatic transporting apparatus 160 and complete the cleaning process of the particle monitoring device 400 or the tray 142.

In conclusion, the skill in the art can readily appreciate that with the provision of the automatic cleaning container 500 to the cleanroom 10, the tray 142 and the particle-monitoring device 400 can be readily and easily cleaned on side. The efficiency is lifted, and the laborious cost is tremendously reduced.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A cleanroom for storing glass substrates configured with a particle monitoring device and an automatic cleaning container for automatically cleaning the particle monitoring device, the automatic cleaning container including:
a container body provided with a plurality of nozzles mounted on a sidewall of the container body;
a cover attached to the container body to jointly define a cleaning space; and
a controlling unit manipulating on or off to the nozzles to perform the cleaning process, and also open and close of the cover.

2. The cleanroom as recited in claim 1, wherein the cover is embodied as a roller curtain.

3. A cleanroom for storing glass substrates and configured with a particle monitoring device, wherein the cleanroom is arranged with an automatic cleaning container to automatically perform cleaning process to the particle cleaning device.

4. The cleanroom as recited in claim 4, wherein the cleanroom is incorporated with towers defining with a plurality of storing cells, each of the storing cells including:
a tray cell for a tray in which glass substrates are stored therein; and
an automatic cleaning cell in which the automatic cleaning container is disposed therein.

5. The cleanroom as recited in claim 3, wherein the automatic cleaning container comprises
a container body provided with a plurality of nozzles mounted on a sidewall of the container body;
a cover attached to the container body to jointly define a cleaning space; and
a controlling unit manipulating on or off to the nozzles to perform the cleaning process, and also open and close of the cover.

6. The cleanroom as recited in claim 5, wherein the cover is embodied as a roller curtain.

7. The cleanroom as recited in claim 4, wherein the particle-monitoring device includes:
a particle counter monitoring the number of the particles;
a wireless communication module interconnected to the particle counter, and in communicating with an external control center; and
a power supply electrically interconnected and providing power to the particle counter and the wireless communication module.

8. The cleanroom as recited in claim 7, wherein the particle monitoring device further includes a bracket attached to the tray cell so as to install the particle counter, the wireless communication module, and the power supply thereon.

9. The cleanroom as recited in claim 4, wherein the cleanroom is incorporated with an automatic transporting apparatus for moving the tray and the particle-monitoring device.

10. The cleanroom as recited in claim 9, wherein the automatic transporting apparatus includes a forklift for moving the tray and the particle-monitoring device.

11. An automatic cleaning container for cleaning a particle monitoring device, and a tray, comprising:
a container body provided with a plurality of nozzles mounted on a sidewall of the container body:
a cover attached to the container body to jointly define a cleaning space; and
a controlling unit manipulating on or off to the nozzles to perform the cleaning process, and also open and close of the cover.

12. The cleanroom as recited in claim 11, wherein the cover is embodied as a roller curtain.
